(19) United States
(12) Patent Application Publication
(10) Pub. No.: US 2020/0302365 A1
(43) Pub. Date: Sep. 24, 2020

(54) LIFECYCLE ACTIVITY TESTING AND ERROR RESOLUTION

(71) Applicant: ServiceNow, Inc., Santa Clara, CA (US)

(72) Inventors: Leena Gian Dudani, Sunnyvale, CA (US); Kenneth James Rudy Hamer, Ramona, CA (US); Harivijay Srikanth Gunuru, San Jose, CA (US)

(21) Appl. No.: 16/357,651

(22) Filed: Mar. 19, 2019

(51) Int. Cl. G06Q 10/06

(52) U.S. Cl. CPC G06Q 10/06316; G06Q 10/0633

(57) ABSTRACT

The present approach relates to techniques that may be used to test and troubleshoot complex chains of activities (e.g., tasks), often associated with multiple actors and long time frames, in an efficient manner. In particular, functionality is provided for testing changes to a process flow comprising a complex chain of activities and/or for testing a given process flow under different circumstances, such as testing for errors when applied to individuals having certain characteristics, locations, and so forth.

### TECHNICAL FIELD

The present disclosure relates in general to approaches for testing for and resolving in automated, complex process flows having dynamic and non-dynamic activity nodes as well as resuming broken or disrupted process flows.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

In an enterprise or organization, certain operations may be managed using one or more applications or resources running on a cloud-platform. Such operations may be associated with a lengthy chain of activities or task that may span days, weeks, months or years and that may include actions to be performed by multiple actors. Further, certain downstream actions may be conditional on decisions or actions performed prior or by other actors. In some contexts, computer- and cloud-based approaches may be employed to design, implement, and track such process flows associated with defined activities performed in an organization or enterprise. However, due to the complexity of the activity interrelationships, the lengthy time frames that may be involved, the potential number of actors, and so forth, it may be difficult to troubleshoot failures in a given flow in an efficient manner.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach relates to techniques that may be used to test and troubleshoot complex chains of activities (e.g., tasks), often associated with multiple actors and long time frames, in an efficient manner. In particular, functionality is provided for testing changes to a process flow comprising a complex chain of activities and/or for testing a given process flow under different circumstances, such as testing for errors when applied to individuals having certain characteristics, locations, and so forth. In addition, functionality is provided for allowing only portions (e.g., a temporal subset) of the process flow to be tested while excluding upstream or downstream portions. Further, functionality may be provided for, in a production environment, restarting a failed process flow from the point of failure, as opposed to having to repeat previously completed steps.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a virtual server supports and enables the client instance, in accordance with aspects of the present disclosure;

FIG. 5 depicts an example of a screen for reviewing and managing a personalized workflow, in accordance with aspects of the present disclosure;

FIG. 6 depicts the screen of FIG. 5 with testing options additionally displayed, in accordance with aspects of the present disclosure;

FIG. 7 depicts an example of a screen for configuring one or more search parameters to identify a test subject, in accordance with aspects of the present disclosure;

FIG. 8 depicts the screen of FIG. 7 with selectable options for configuring the screen displayed, in accordance with aspects of the present disclosure;

FIG. 9 depicts the screen of FIG. 7 configured with a condition for identifying a test subject, in accordance with aspects of the present disclosure;

FIG. 10 depicts an example of a screen depicting test subjects meeting one or more search criteria, in accordance with aspects of the present disclosure;

FIG. 11 depicts an example of a workflow and test screen personalized based on a selected test subject, in accordance with aspects of the present disclosure;

FIG. 12 depicts an example of a screen that may be displayed as a test preview step is performed, in accordance with aspects of the present disclosure;

FIG. 13 depicts an example of a screen displayed after a test preview in which applicable activities are shown along with inapplicable and indeterminate activities, in accordance with aspects of the present disclosure;

FIG. 14 depicts the screen of FIG. 13 with user selectable options to override the exclusion of certain inapplicable and indeterminate activities, in accordance with aspects of the present disclosure;

FIG. 15 depicts the screen of FIG. 14 with certain activities overridden for inclusion or exclusion in a test, in accordance with aspects of the present disclosure;

FIG. 16 depicts an example of a screen displayed after a test process and displaying a link to a corresponding set of test results, in accordance with aspects of the present disclosure; and

FIG. 17 depicts an example of a test results screen, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

The present approach relates to techniques that may be used to test and troubleshoot complex sequences of activities (e.g., a process flow), which may be provided as tasks to one or more individuals or groups. Such activities are often associated with multiple actors and long time frames and may be difficult to test or troubleshoot in an efficient manner. In particular, approaches are discussed herein for testing changes to a process flow comprising a complex chain of activities and/or for testing a given process flow under different circumstances, such as testing for errors when applied to individuals having certain characteristics, locations, and so forth. In addition, functionality is provided for allowing only portions (e.g., a temporal subset) of the process flow to be tested while excluding upstream or downstream portions. Further, functionality may be provided for, in a production environment, restarting a failed process flow from the point of failure, as opposed to having to repeat previously completed steps.

In order to provide useful, real-world perspective, certain of the examples of process flows discussed herein may be put in the context of lifecycle events. Such lifecycle events are examples of complex process flows comprising milestones and associated activities or tasks that may be designed and tracked in an organization using suitable applications related to and/or impacting human resource management, accounting, information technology management, and so forth. Examples of such lifecycle events include, but are not limited to, employee on-boarding, employee off-boarding, employee relocation and/or reassignment, employee promotion or other changes within an organization, and so forth. It should be appreciated however, that while such lifecycle events are useful examples of real-world process flows, the present techniques are suitable for use with various other types of complex process flows, and are not limited to use in the context of such lifecycle events.

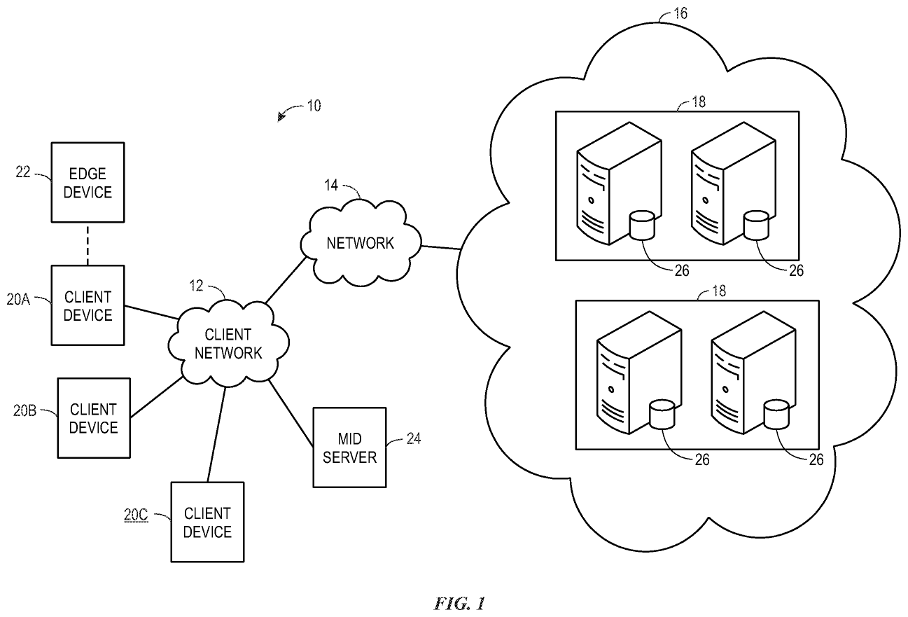

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized, though other system implementations, including on a stand-alone local area network, wide area network, or even on a stand-alone computer, are also possible. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, agent, or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

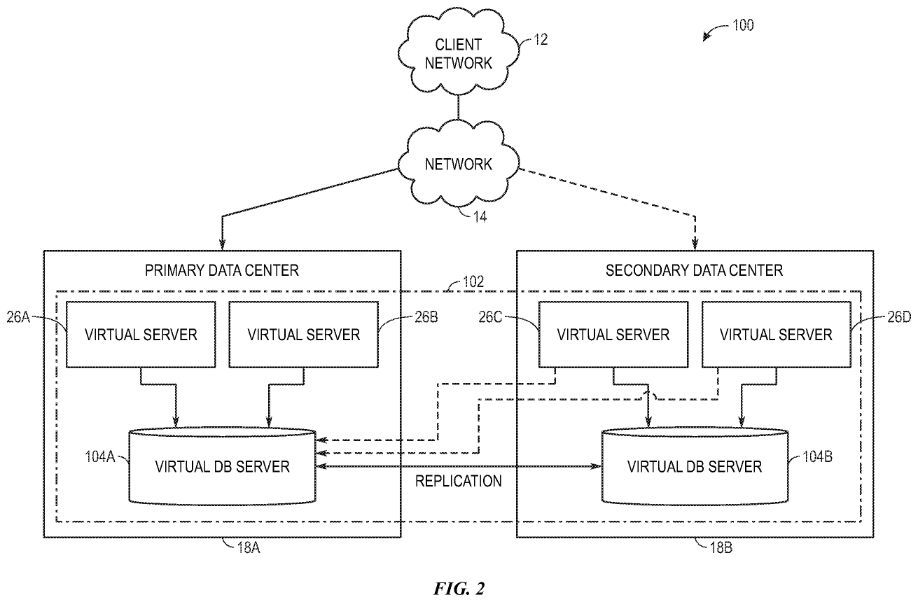

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

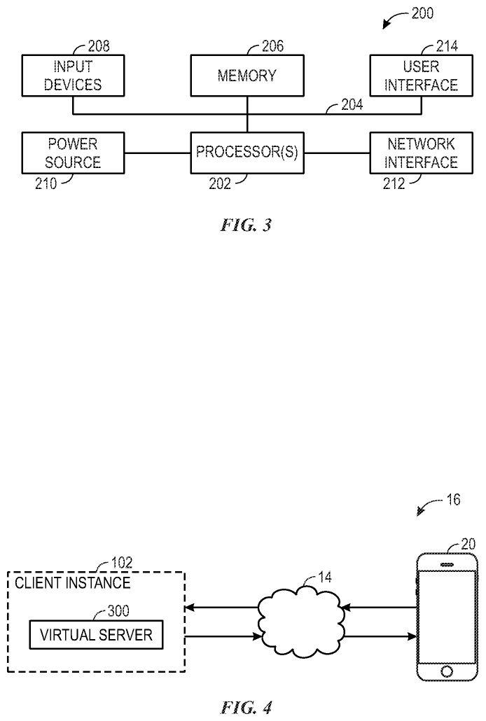

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

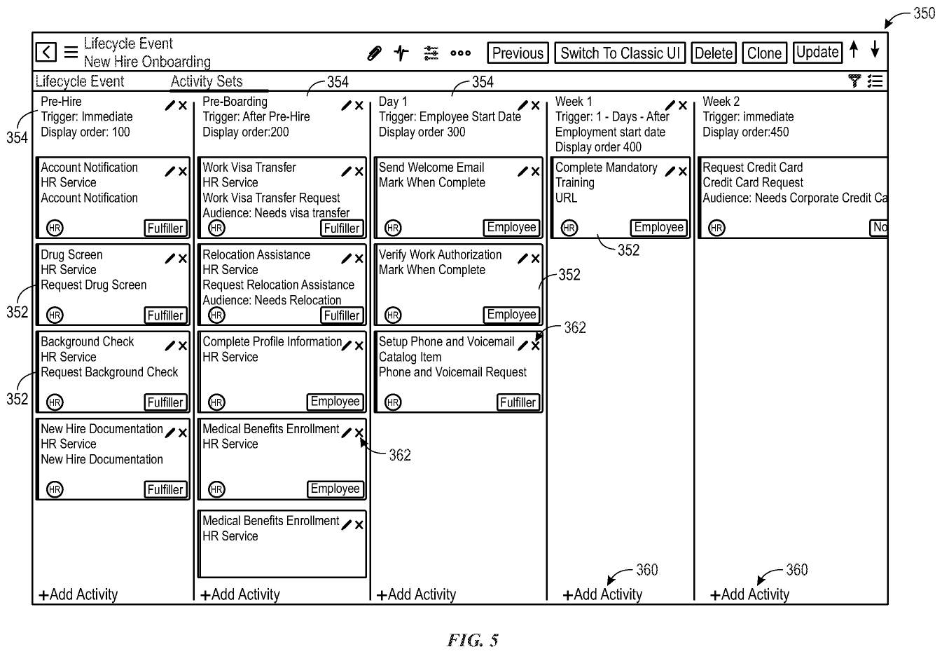

With the preceding in mind, FIG. 4 is a block diagram illustrating an embodiment in which a virtual server 300 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser.

With the preceding in mind, the present approach relates to techniques that may be used to test and troubleshoot complex sequences of activities (e.g., a process or workflow, such as may be associated with a series of tasks to be performed for a lifecycle event). Such activities may be provided as tasks to perform by one or more individuals or groups (i.e., fulfillers). Such activities are often associated with multiple actors and long time frames and may be difficult to test or troubleshoot in an efficient manner. In particular, approaches are discussed herein for facilitating such testing and troubleshooting operations, as well as for resuming broken process flows in an efficient manner.

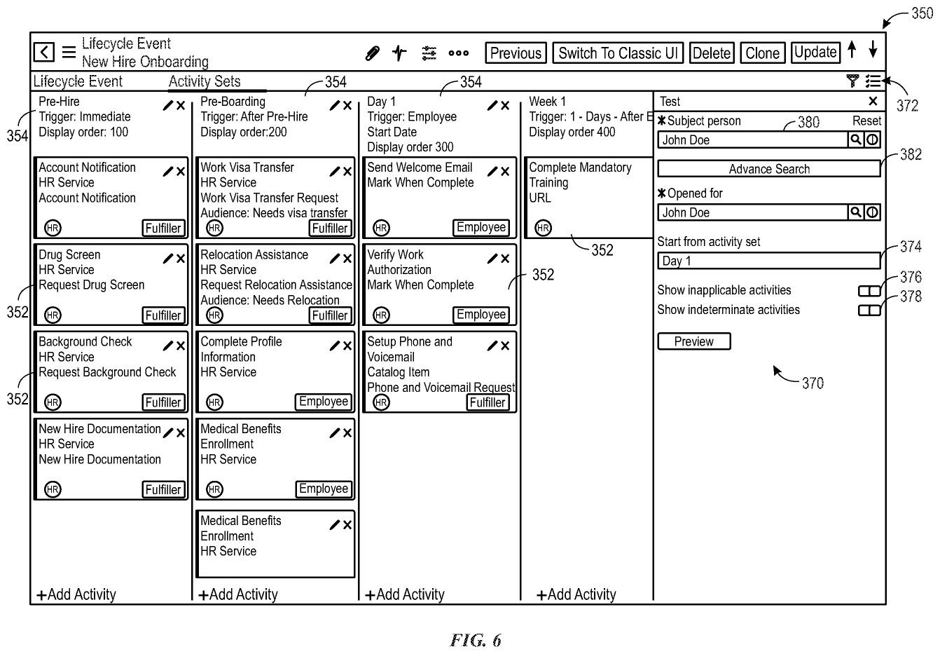

With this in mind, and turning to FIG. 5, an example is provided of a screen 350 that may be employed for viewing and/or managing a lifecycle event for an employee, which as noted above may be one example of a type of process flow for which the present techniques are suited. In this example, various activities 352 (here depicted as cards containing summary activity information) are arranged under sequential milestones 354 (which may be based on dates or time ranges). The activities 352 listed under each sequential milestone 354 represent the activities or tasks to be performed on or by that milestone and may include a task or activity title and/or descriptor as well as an associated fulfiller (i.e., person or entity responsible for performing the task.

In the depicted example, the workflow is related to “New Hire Onboarding” and includes milestones 354 based on “Pre-Hire”, “Pre-Boarding”, “Day 1”, “Week 1”, “Week 2”, and further into the future. For each milestone 354 appropriate activities 352 are listed underneath as separate cards that describe the task to be completed and the respective fulfiller of the activity 352. Options to add (control 360) or delete (controls 362) are also provided to add or delete activities for the respective workflow. Similarly, additional milestones 354 may be added (or existing milestones 354 removed) if needed.

In practice, certain activities 352 may be conditional on other activities being completed, such as in a preceding milestone 354. In addition, certain activities 352 may not apply to all individuals (such as based on age, gender, job title, educational background, citizenship status, and so forth), or may have different applicability based on geographic location or jurisdiction (i.e., different cities, states or countries may have different laws or regulations). As a result, the interrelationship among activities can be complex not just due to a logical interrelationship between activities, but also due to factors such as individual demographics or characteristics, geographic location, and legal jurisdiction.

In the depicted example, the workflow illustrated is a personalized workflow and illustrates activities and milestones associated with a designated individual (in this example, an individual being onboarded as a new hire). Thus, as activities 352 are performed and milestones 354 reached, the personalized workflow may be updated to reflect the milestones 354 being reached, activities 352 being completed (or not being completed) and so forth).

An aspect of the personalization of the workflow is that only applicable activities should be triggered for completion for a given individual. Thus, each activity 352 may have an associated trigger or condition that determines if it will apply. By way of example, an activity related to providing information related to retirement account catch-up contributions may be applicable only to individuals age 50 or older in a given year, and thus may not be included as an activity for those not meeting this age requirement. Similarly, other activities may be specific to a geographic location or legal jurisdiction, so that an individual's location determines whether certain activities 352 apply and are shown.

With these considerations in mind, it may be appreciated that the variety of possible workflow activity combinations for a given process (e.g., employee onboarding in the depicted example) may be large and it may be difficult to test all possible flows for logical continuity and possible errors. The present approach addresses this difficulty by providing simplified test functionality to that a given set of condition and a given workflow can be tested, either in its entirety or from a specified time or milestone 354.

Turning to FIG. 6, such testing may be implemented to allow a user to perform criteria and condition testing for a personalized workflow, as described herein. Such testing may allow a user to test particular use cases, such as to make sure activities that should or should not be triggered in a given personalized workflow perform as expected. As discussed herein, such testing may take into account location and/or jurisdiction, personnel information, a subset of activities or activities occurring on certain milestones or dates, and so forth.

To facilitate the testing process, a set of testing options 370 may be toggled to display (or be hidden) by selection of a testing icon 372. The testing option 370 in the depicted example include a slider 376 that controls whether inapplicable activities are displayed (where inapplicable activities are those that, for a given subject, are known not to apply) and a slider 378 that controls whether indeterminate activities are displayed (where indeterminate activities are those that, for a given subject, are conditional and may or may not apply depending on an event or answer provided earlier in the workflow).

In addition, the testing options 370 in the depicted example include a start selector 374 through which an activity, date, or milestone, may be selected or otherwise specified and from which the test process will proceed from. That is, activities and/or milestones occurring before the selected start time/activity are not processed as part of a test run. This helps increase efficiency of the testing process as known good portions of a workflow can be skipped and/or a known bad portion can be more closely focused on. In addition, though not shown, an option may additionally or alternatively be provided to specify an end time or activity so that testing is terminated after testing a portion of the workflow without processing the remainder of the workflow.

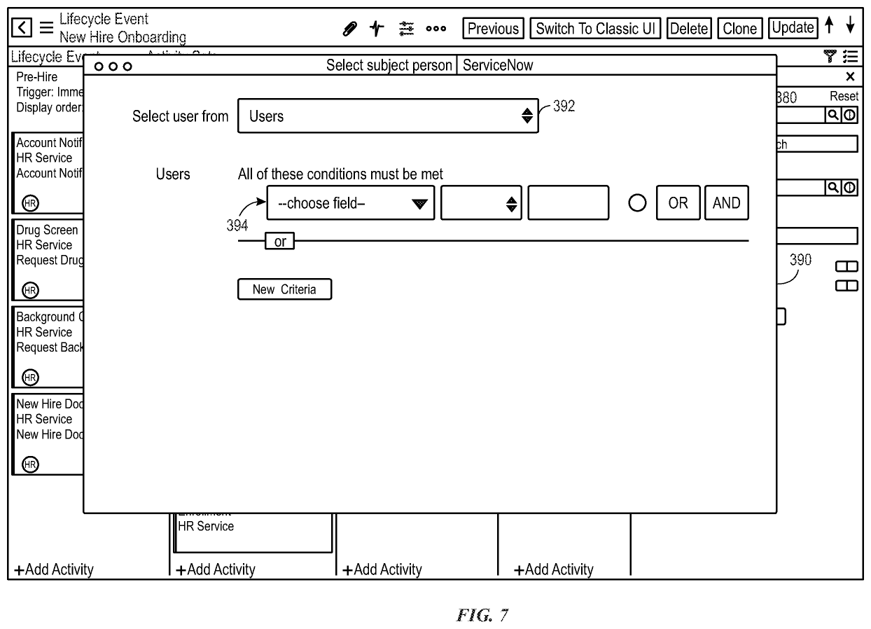

A subject person may also be specified (field 380) having one or more characteristics consistent with the testing to be performed. That is, if the workflow is to be tested for continuity with respect to individuals from a certain location or having a certain demographic characteristic, a subject person may be selected who has the desired characteristics or location so that the corresponding personalized workflow is appropriate for the contemplated test. A suitable subject person may identified by performing a search of available individuals. In the depicted example, such a search may be invoked using a search button 382, which invokes a search customization screen, as shown on FIG. 7.

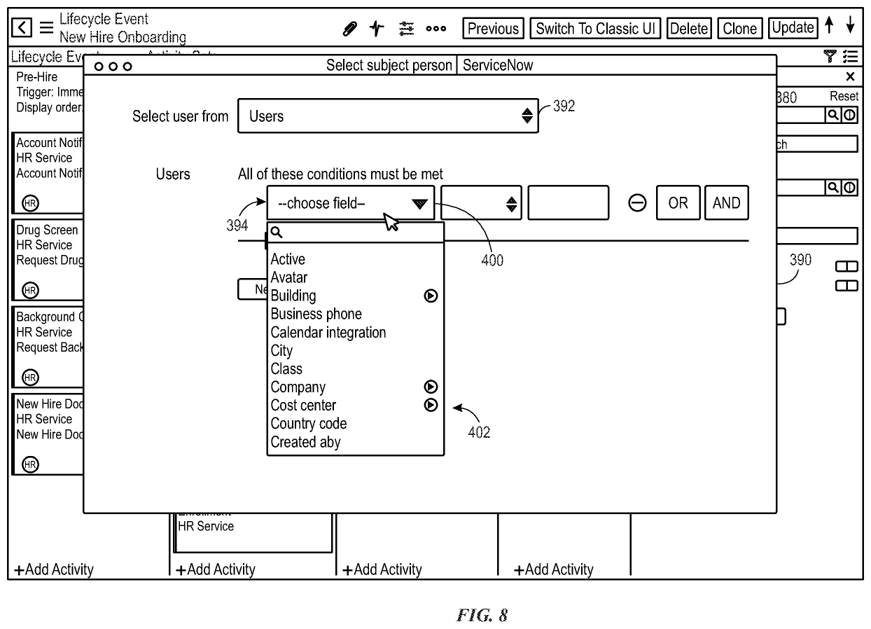

Turning to FIG. 7, the advanced search screen 390 of the present example is configurable to allow a searcher to select a subject person from different sets or subsets of users (as shown be selection box 392) and based on one or more conditions 394 specified by the searcher. This is illustrated in FIGS. 8-10 where, turning to FIG. 8, a field 400 in which a subject person characteristic (e.g., a demographic characteristic, location or jurisdiction characteristics, employment characteristics, and so forth) may be defined. In this example, selection of the field 400 causes the display of a list 402 of available characteristics, one of which can be selected by the user on the interface.

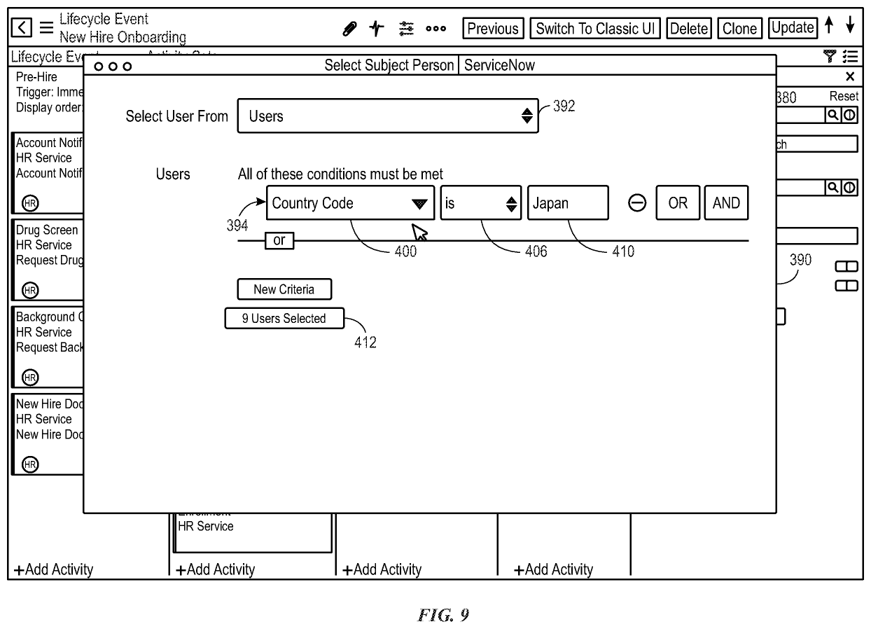

Turning to FIG. 9, an example is illustrated where “country code” (i.e., a geographic characteristic) has been selected in field 400. In addition a logical operator (here “is”) is specified in configurable field 406 and a country (here “Japan”) is specified in field 410 such that the condition “country code is Japan” is specified as a condition for identifying a subject person for a test process. Based on this criterion, an indicator 412 that dynamically indicates the number of matches based on the currently specified criteria is displayed. A user of the interface may view this indicator to determine if enough, too few, or too many individuals are matched based on the specified criterion and may modify, add, or delete criteria as needed to identify a suitable test pool.

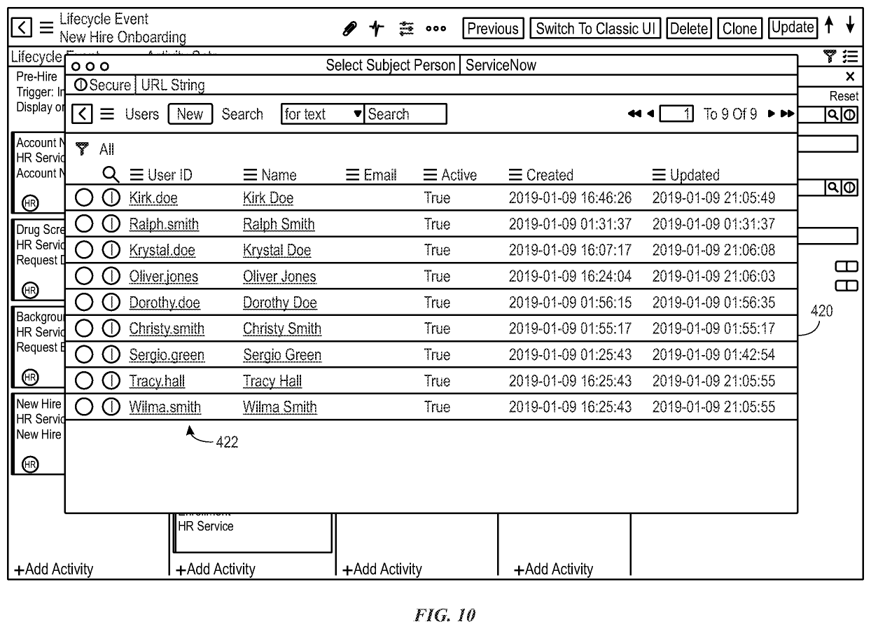

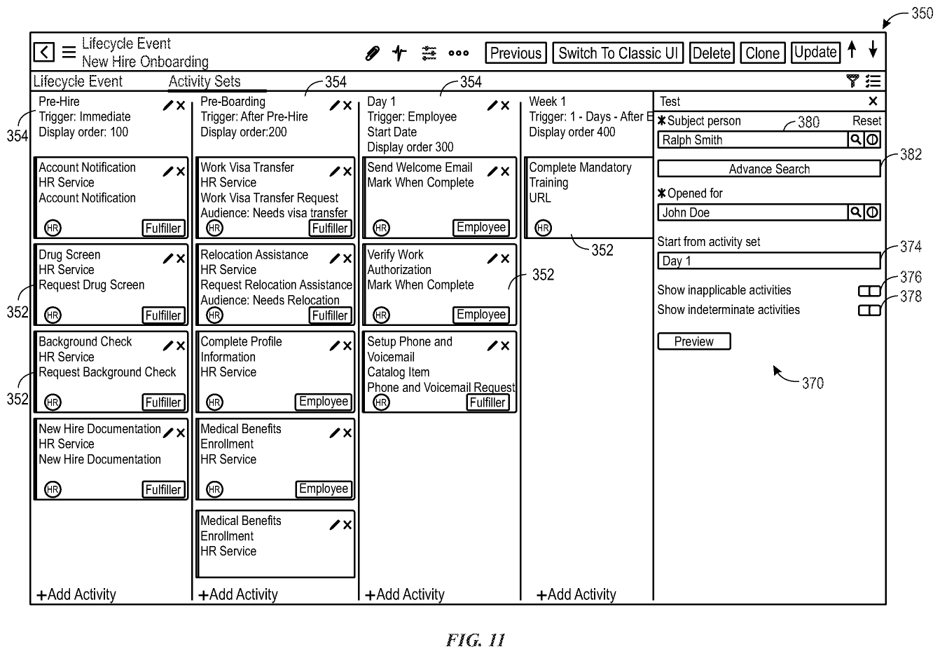

Once the criteria are deemed satisfactory, a user of the interface 390 may select (i.e., press) the indictor 412, causing a list 420 of matches 422 to be displayed, as shown in FIG. 10. The user may then select a suitable subject person from the list of matches 422 for the contemplated test process. This is illustrated in FIG. 11 where, as illustrated, the test options 370 have been updated to include the selected subject person at field 380. In this example, the selected subject person has the characteristic(s) to be tested in the contemplated test case scenario, and thus can be used to test the integrity of the workflow in question for a person have those characteristics. Thus, once selected, the personalized workflow displayed to the left of the test pane is particular to the selected subject and includes the activities 352 and logical interrelationships between activities to be tested.

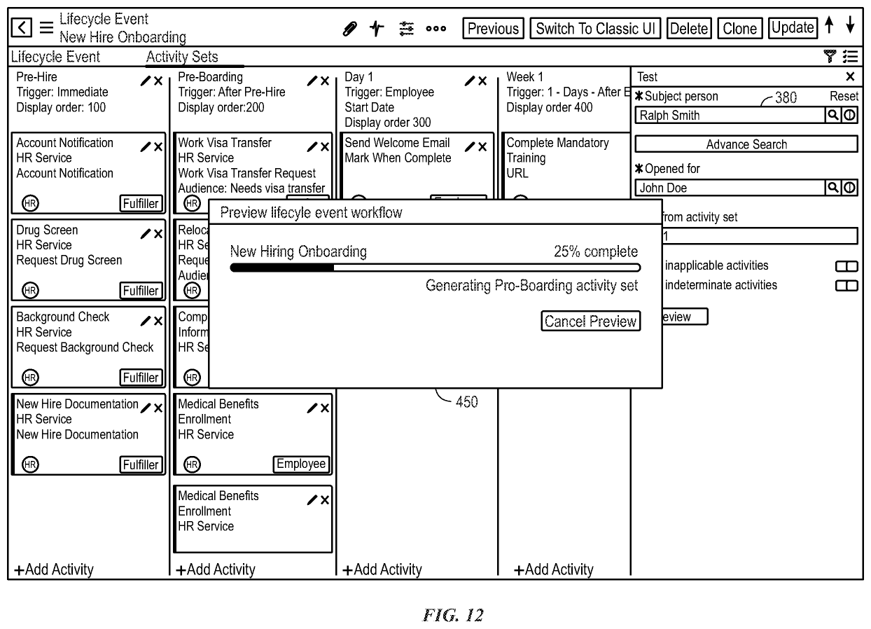

Once the test subject and associated personalized workflow are selected, a user of the interface may selected an option to perform a preview (e.g., selecting preview button 440) of the selected lifecycle (e.g., workflow). An example of such a preview operation being performed is shown in FIG. 12, where a progress pane 450 is shown depicting the steps and percent completion of such a workflow simulation process. During this preview process, the simulation determines that activities will apply and which will not based on the subject's characteristics.

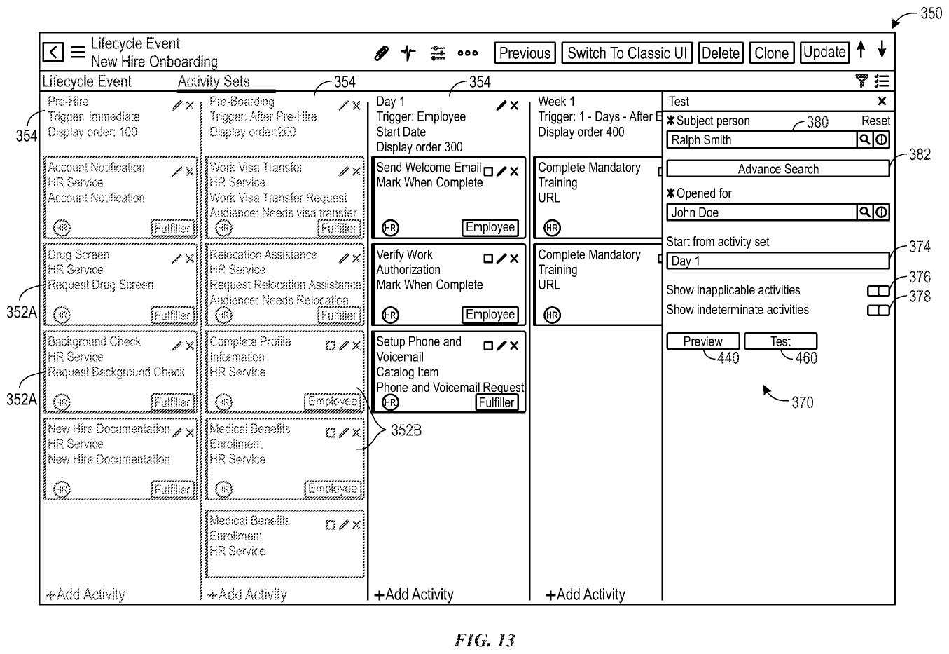

Once the preview step is completed, preview results are provided, as shown in in FIG. 13. Based on the results of the lifecycle simulation operation performed as the preview step, activities 452 may be visually flagged as activities that apply to the subject (applicable activities 352A) in the test case scenario and those that do not (inapplicable or indeterminate activities 352B) (differentiated by the absence or presence of shading in the depicted example). In addition, subsequent to the preview step being concluded, an option to perform a test run (e.g., test button 460) may be made active and selectable.

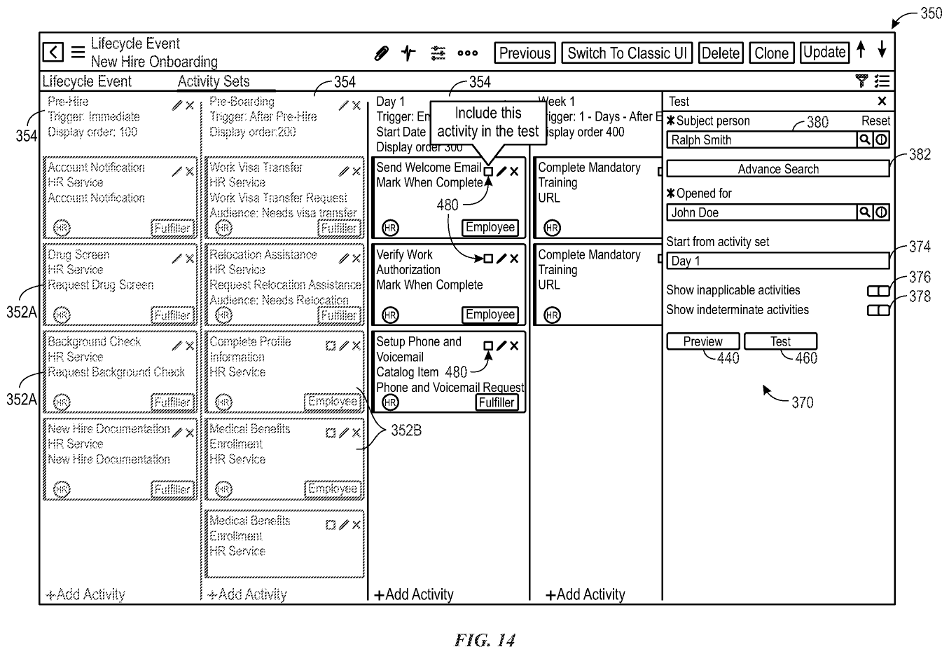

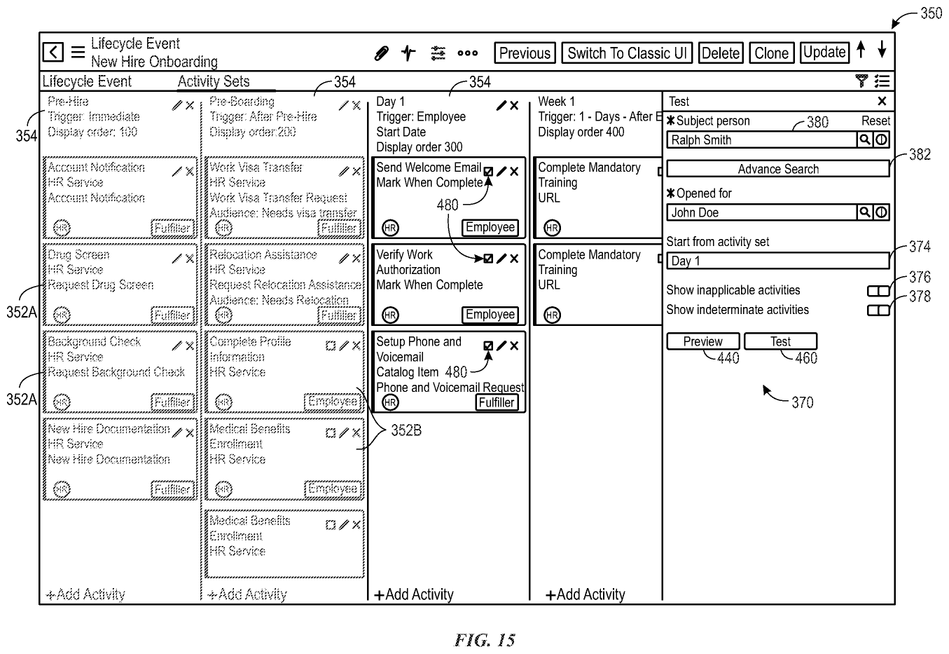

A user of the interface, based on the preview results, may opt to include or exclude inapplicable activities 352B from the actual testing process. For example, as shown in FIGS. 14 and 15 inapplicable or indeterminate activities 352B may be displayed with a checkbox 480 or other selectable option to allow a user of the interface to manually flag (i.e., override) indeterminate or inapplicable activity 352B to be included in the testing process. In addition, this capability may be expanded to include all activities in the workflow, including applicable activities 352A, so that a user of the interface has full flexibility in including or excluding any activity 352 from the testing process.

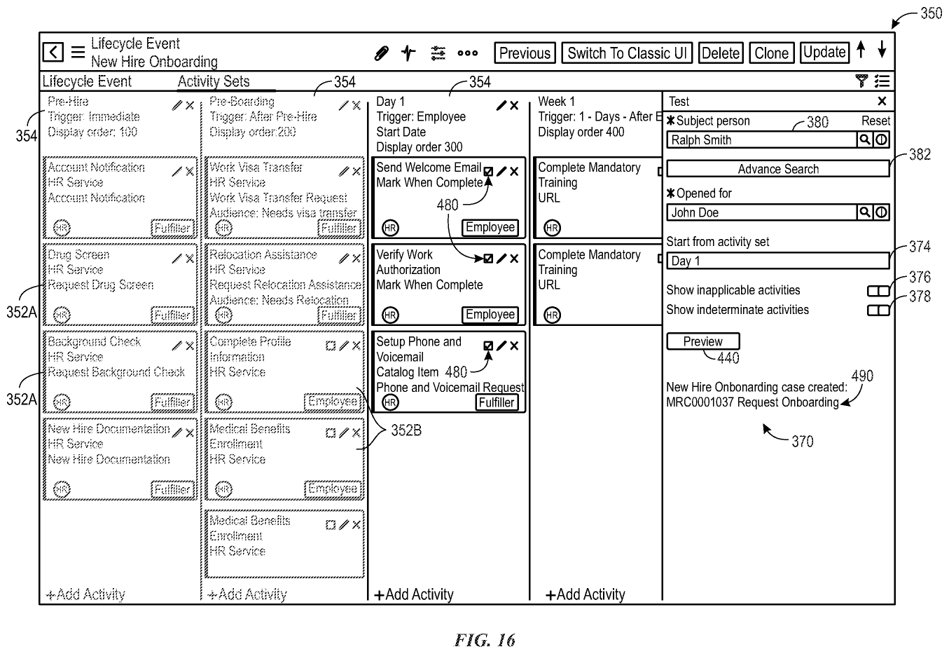

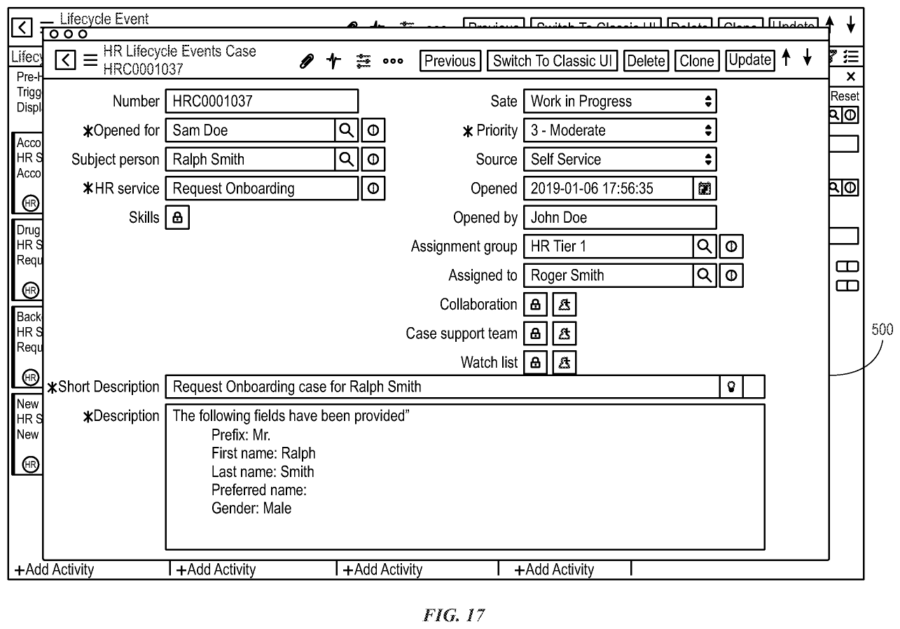

Once a user adds any indeterminate or inapplicable activity 352B that are to be included, the test button 46 may be selected, prompting the test process to run for the active and selected activities 352, from the date or time specified (field 374), and based on the characteristics of interest of the subject. In particular, the test process tests the logical interconnections and activity triggers based on the specified activities, as discussed herein. Upon completion of the test process, a test result file 490 may be created, as shown in FIG. 16.

The test result file 490 may be opened, as shown in FIG. 17, to display the test case results 500 for the respective test run. The test results may be reviewed to determine which activities 352 triggered and which did not, allowing a reviewer to determine if any activities triggered that were not supposed to, if any activities did not trigger that were supposed to, and so forth. In addition, the test results may indicate whether a given activity triggered at the correct time and/or in response to the appropriate trigger conditions. Based on these results, a user of the interface can return to the preceding test set-up screen and add or remove activities as appropriate to re-run the test, such as to test further scenarios to see if problems persists or are addressed by the addition or removal of activities 352 from the test case scenario.

With the preceding in mind, the above-described testing functionality provides several advantages over conventional approaches. In accordance with the present techniques, a workflow can be simulated during development or design with particular test cases or individual circumstances in mind so as to confirm that needs tasks and activities activate as intended. Likewise, testing can be limited based on dates or milestones so as to avoid testing portions of the workflow that are not at issue or otherwise not of concern.

The preceding relates to testing or troubleshooting, which may be done in a test or other non-production environment. Certain of the above-described concepts may also be leveraged in a production environment to provide certain benefits with respect to recovering or restarting a workflow in the event of a stop or break in the flow.

By way of example, in a production environment where a personalized workflow has been performed up through a given activity and milestone, and error or break in the workflow may occur that results in subsequent activities not being triggered. In conventional approaches, the entirety of the workflow would be canceled and restarted, resulting in wasted time and resources.

In contrast, aspects of the present approach would instead allow a personalized workflow to be resumed at the point where the workflow stopped. Unlike the test scenario outlined above, a test case is not created. Instead, in the resume context an existing case with activity data and feedback is already present in the production environment. The resume action can re-run activities and milestones in the personalized workflow while checking for the corresponding data in the production environment (e.g., the corresponding task or activity tables in the relevant databases) until an activity is reached in the workflow for which the data is not present, i.e., the point at which the workflow stopped. The first activity in the workflow for which data is missing may then be used to trigger that activity, automatically resuming the workflow at the point at which it was disrupted.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
one or more client instances hosted by a platform, wherein the one or more client instances support application and data access on one or more remote client networks, wherein an application executing on the system is configured to perform workflow test operations comprising:
displaying an interface comprising set of test options for a workflow test process;
receiving a test subject input on the interface designating a test subject for a workflow test case, wherein the test subject comprises one or more characteristics specific to the workflow test case;
in response to the test subject input, generating a personalized workflow for a process or event applicable to the test subject, wherein the personalized workflow comprises a plurality of activities to be performed to accomplish the process or event, and wherein at least one respective activity has an associated trigger condition related to a respective characteristic of the test subject;
processing the personalized workflow to identify at least those activities applicable to the test subject;
performing a simulated run of all or part of the personalized workflow to determine whether those activities applicable to the test subject trigger properly; and
providing a set of test results for review, wherein the set of test results comprise indications as to whether those activities applicable to the test subject triggered properly in the simulated run.

2. The system of claim 1, wherein the set of test options comprises a configurable start option configured to receive an input specifying a location in the personalized workflow from which to start the simulated run.

3. The system of claim 1, wherein the set of test options comprises a selectable search interface through which the one or more characteristics is specified to identify a list of potential test subjects from which the test subject is selected to generate the test subject input.

4. The system of claim 1, wherein the plurality of activities of the personalized workflow are associated with respective milestones corresponding to a sequence or timing.

5. The system of claim 1, wherein the one or more characteristics of the test subject comprises one or more of a demographic or personal characteristics, a geographic location, a legal jurisdiction, or an employment characteristic.

6. The system of claim 1, wherein processing the personalized workflow to identify at least those activities applicable to the test subject further comprises also identifying those activities that are inapplicable or indeterminate.

7. The system of claim 6, further comprising:
for each activity, providing a selectable option to include or exclude activities in the simulated run.

8. The system of claim 1, wherein the set of test results comprise further indications as to whether activities that should not be triggered were triggered, whether activities that should be triggered were not triggered, and whether activities were triggered at the correct time or in response to the correct trigger conditions.

9. A method for testing an automated workflow process, comprising:
receiving a selection of a workflow comprising activities to be performed to complete an event or process, wherein one or more of the activities have respective trigger conditions to be met to trigger the activity;
receiving a selection of a test subject having one or more characteristics specific to a test case scenario to be evaluated;
personalizing the workflow based on the selection of the test subject to generate a personalized workflow, wherein the personalized workflow comprises at least one respective activity having an associated trigger condition related to a respective characteristic of the test subject;
identifying one or more activities of the personalized workflow applicable to the test subject;
simulating a run of all or part of the personalized workflow to determine whether those activities applicable to the test subject trigger properly; and
providing a set of test results for review, wherein the set of test results comprise indications as to whether those activities applicable to the test subject triggered properly in the simulated run.

10. The method of claim 9, further comprising:
receiving a selection of a start point within the personalized workflow from which simulating the run so as to exclude portions of the personalized work flow preceding the start point from simulation.

11. The method of claim 9, wherein the respective trigger conditions comprise logical or conditional requirements related to one or more respective preceding activities.

12. The method of claim 9, wherein the one or more characteristics of the test subject comprises one or more of a demographic or personal characteristics, a geographic location, a legal jurisdiction, or an employment characteristic.

13. The method of claim 9, further comprising:
displaying a search interface through which the one or more characteristics is specified to identify a list of potential test subjects, wherein the selection of the test subject is from the list of potential test subjects.

14. The method of claim 9, wherein the workflow comprising milestones is organized based on milestones, wherein each milestone comprises one or more respective activities.

15. The method of claim 9, wherein the set of test results comprise further indications as to whether activities that should not be triggered were triggered, whether activities that should be triggered were not triggered, and whether activities were triggered at the correct time or in response to the correct trigger conditions.

16. A workflow testing interface, comprising:
a personalized workflow view comprising a plurality of activities;
a test option interface, comprising at least:
a test subject field in which a test subject is specified; and
a start location field in which a start location in the personalized workflow is specified;
a first selectable option configured to, when selected, process the plurality of activities to identify at least those activities of the personalized workflow that apply to the test subject; and
a second selectable option configured to, when selected, perform a simulation based on the test subject and at least those activities of the personalized workflow that apply to the test subject to determine whether those activities applicable to the test subject trigger properly.

17. The workflow testing interface of claim 16, wherein the plurality of activities of the personalized workflow are organized by milestones.

18. The workflow testing interface of claim 16, wherein the test option interface further comprises a selectable search option configured to, when selected, invoke a search screen within which one or more search conditions are specified for suitable test subjects.

19. The workflow testing interface of claim 16, wherein the plurality of activities of the personalized workflow view comprise applicable activities for the test subject and inapplicable or indeterminate activities for the test subject.

20. The workflow testing interface of claim 19, wherein the inapplicable or indeterminate activities for the test subject displayed in the personalized view include a selectable option to be included in the simulation.
